(19) United States
(12) Patent Application Publication
(10) Pub. No.: US 2016/0365012 A1
(43) Pub. Date: Dec. 15, 2016

(54) HANGING DISPLAY SYSTEM WITH CLASP

(71) Applicant: Rick Anderson, Minneapolis, MN (US)

(72) Inventor: Rick Anderson, Minneapolis, MN (US)

(21) Appl. No.: 15/155,872

(22) Filed: May 16, 2016

Related U.S. Application Data
(60) Provisional application No. 62/161,351, filed on May 14, 2015.

(51) Int. Cl. G09F 7/18; F16B 2/24; F16M 13/02

(52) U.S. Cl. CPC G09F 7/18; F16M 13/027; F16B 2/248; G09F 2007/186; G09F 2007/1839

(57) ABSTRACT

This invention relates to a hanging display system. In particular, the invention relates to hanging display system with a metal clasp that can move easily and securely between an open and closed position. Persons of ordinary skill in the art will understand that the invention is not necessarily so limited.

### RELATED APPLICATIONS

The present application claims priority to, and incorporates by reference U.S. patent application Ser. No. 62/161,351 filed on May 14, 2015.

### BACKGROUND

### Field of the Invention

This invention relates to a hanging display system. In particular, the invention relates to hanging display system with a metal clasp that can move easily and securely between an open and closed position. Persons of ordinary skill in the art will understand that the invention is not necessarily so limited.

### Background of the Invention

In retail and other environments, promotional and marketing display material are commonly affixed to hang from the ceiling. Conventionally, these materials, which can include posters, displays, advertising material, informational signs, product samples, or other materials, are attached from a device hanging from the ceiling. Such systems suffer from a number of drawbacks.

For example, in some applications the display material needs to be replaced frequently and prior art systems utilize fixtures and hardware that make this difficult. Replacement can require the use of ladders and tools that are demanding to use. Small parts associated with display hardware are frequently dropped, broken, or lost which complicates replacement. Additionally, the fixtures and hardware wear out over time, which is especially the case with plastic parts that can become brittle over time, and crack or break from frequent manipulation associated with replacement of displays. Further, prior art systems often lack the strength needed to support heavier displays. In addition, it generally requires manipulation of hardware to move the clasps from a locked to an unlocked position, usually requiring the use of tools.

Accordingly, a need exists for a hanging display system that overcomes the difficulties of the prior art.

### BRIEF DESCRIPTION OF THE FIGURES

FIG. 1 shows various views of a clasp and wire of the present invention in different states of attachment to a display.

FIG. 2 shows the clasp of the present invention in an open and closed position.

FIG. 3 shows the clasp of the present invention attached to a cable/wire.

FIG. 4 shows two clasps of the present invention attached to either end of a wire.

FIG. 5 shows various clasps and wires color-coded for length.

FIGS. 6a and 6b shows various views of different sized clasps of the present invention in open and closed positions.

FIG. 7 shows the hanging display system deployed to suspend a display.

FIG. 8 shows the upper clasp of the display system of FIG. 7, with the clasp in the locked position.

FIG. 9 shows the lower clasp of the display system of FIG. 7, with the clasp in the locked position.

### DETAILED DESCRIPTION OF THE PREFERRED EMBODIMENTS

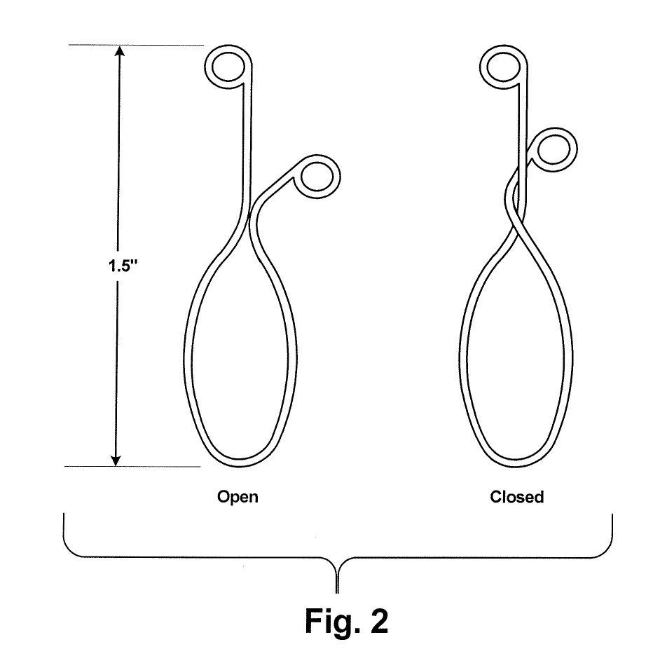

In the Figures, a hanging display system is shown. FIG. 2 shows a clasp 10 of the present invention in the open and closed position. The clasp 10 comprises a section of wire 14 terminating in two closed eyelets 12. One eyelet 12 is below the other. The lower eyelet 12 can be looped around the wire 12 forming an overlap 16, thereby creating a loop 18 in the lower section of the clasp 10. A display 20 can be retained within the loop 18.

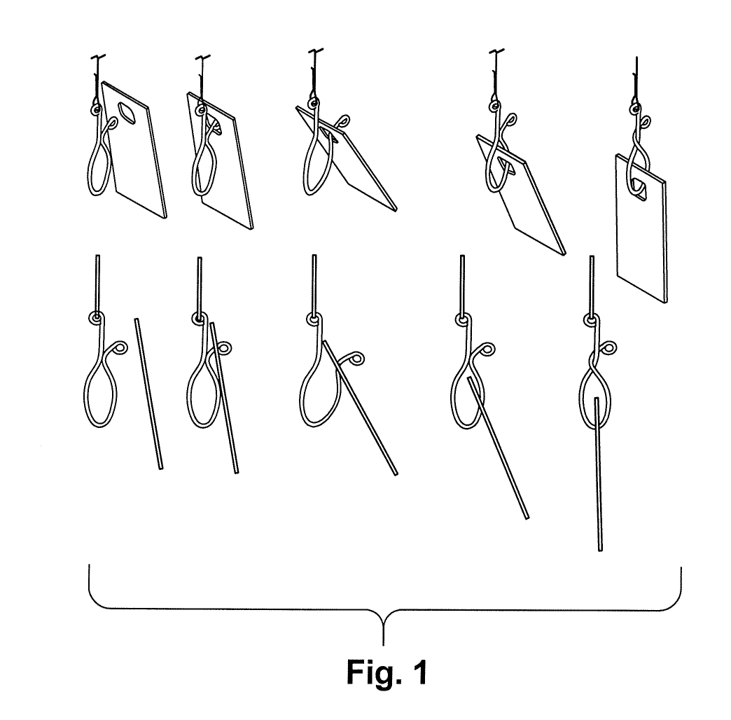

FIG. 1 shows various views of a clasp 10 and display 20 of the system, wherein the top row of views show a perspective of the display 20 being retained within the clasp 10. The lower set of views shows the same thing from a side view.

The clasp is rigid enough to maintain its shape under the load of a supporting a display, but pliable enough to be moved between an open and closed position and allowing the display to be inserted and removed from the loop portion of the clasp. The clasp can engage a display by pressing a hole in the display over the lower eyelet of the clasp. The loop of the clasp is forced apart as the display passes through, and then loop closes—as the clasp is biased toward closing the loop. The clasp can then be locked to prevent the display from disengaging from the clasp by twisting the end with the lower eyelet around the other end of the wire extends down from the upper eyelet.

The clasp can be made from any suitable material, and preferably from a material with a memory for the biased position. Most preferably, the clasp is made from spring wire, which is biased toward the closed position. Even more preferably, the clasp is comprised of 1/32^{nd} spring wire, and is heat treated to provide pliable biasing of the wire.

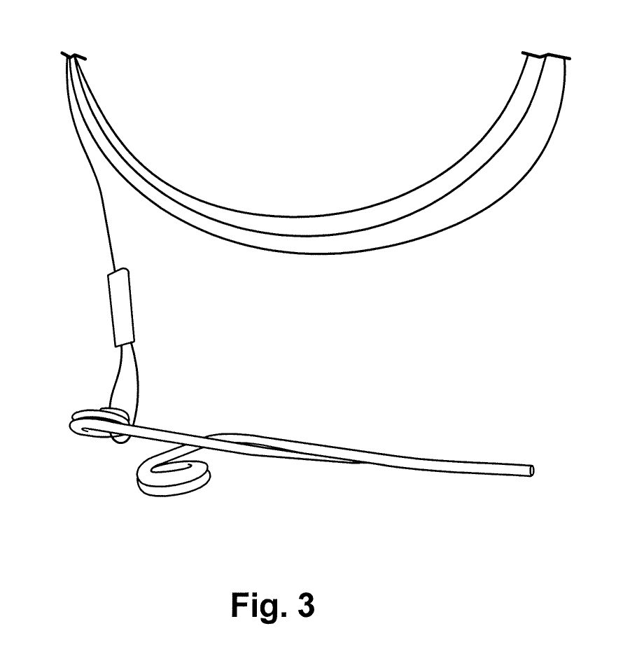

FIG. 3 shows the clasp attached to a loop of wire, which is held in place with a crimped fitting. Preferable the wire is threaded through the eyelet of the clasp then crimped; however, it is possible to pass the loop in the wire through the wound end of the eyelet of the clasp and secure the wire at some point above the clasp.

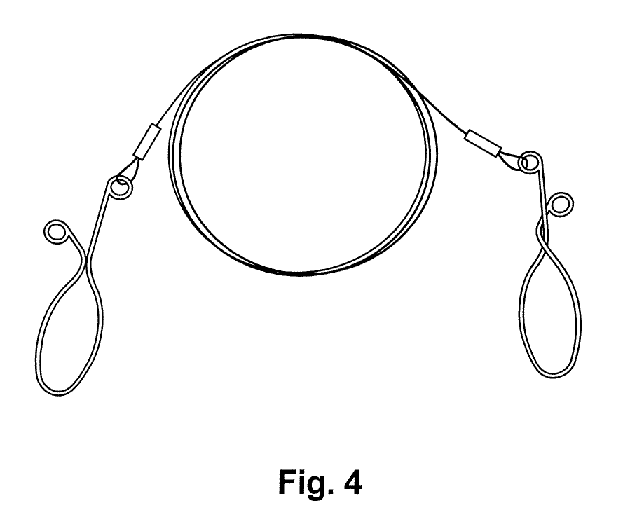

FIG. 4 shows two clasps, attached as described above, to both ends of a wire, which will then allow one claps to be affixed to an attachment point the ceiling and the other clasp to be attached to a display suspended therefrom.

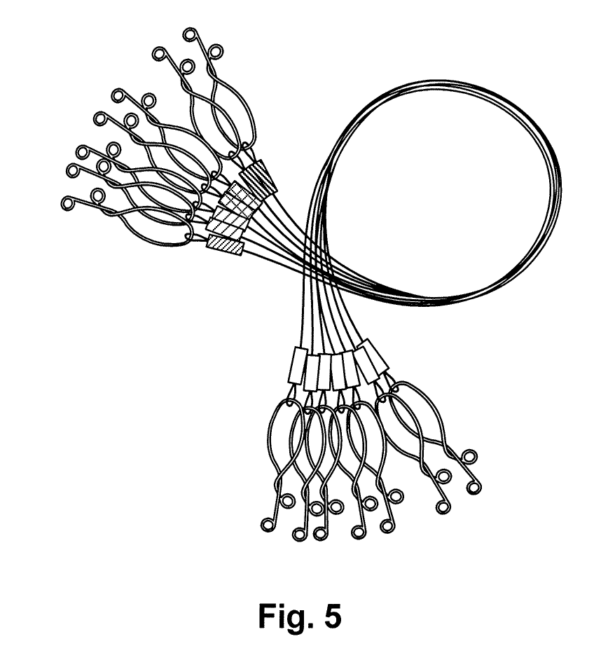

FIG. 5 shows a plurality of clasps and wire combinations that are color-coded for length. In this manner, it is easier to select a length of wire that will allow the display to be at the desired height which will depend on the ceiling height, point of attachment, as well as the type and size of the display.

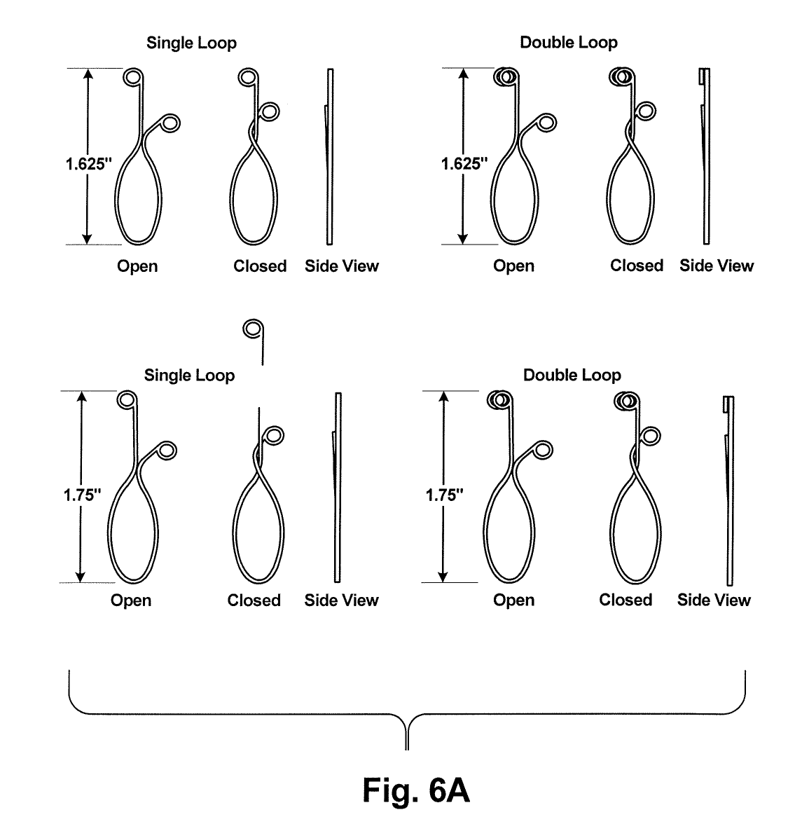

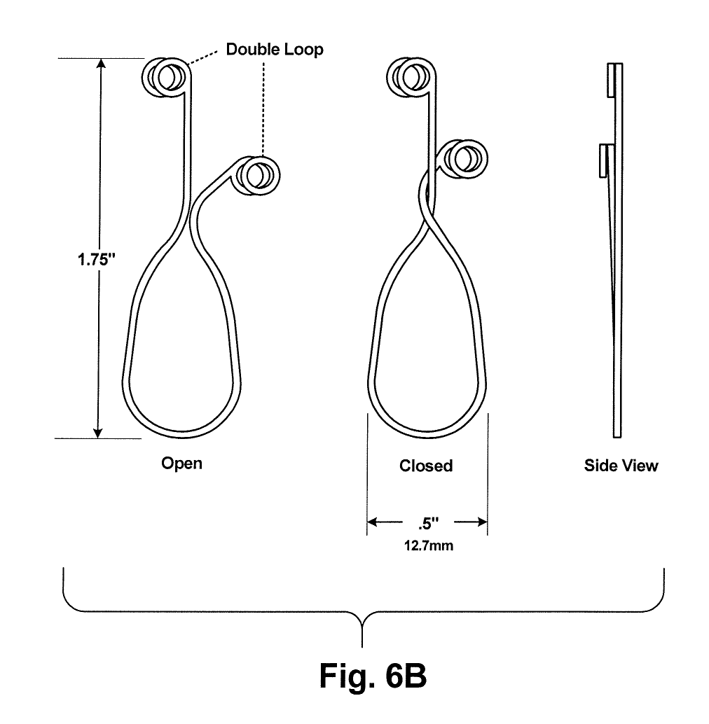

FIGS. 6a and 6b show various claps of differing dimensions both open and closed, and from the side. In addition, the eyelet is shown with a single or double loop.

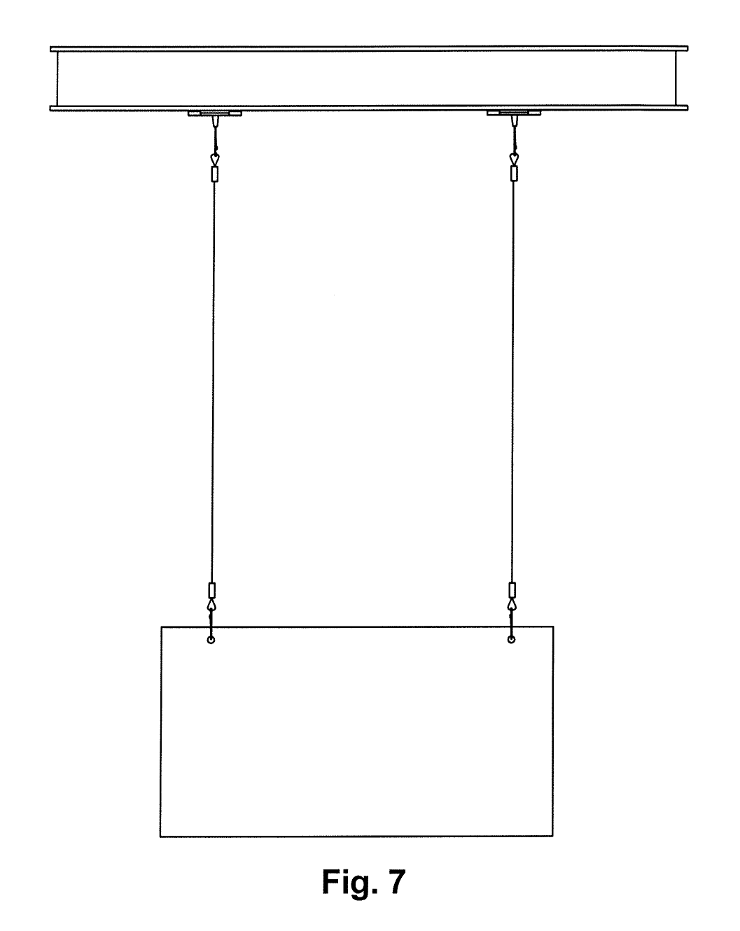

FIG. 7 shows the hanging display system deployed. The system includes a bracket attached to a ceiling member, which has a hook for receipt of the loop portion of the clasp. The eyelet of the clasp is then attached to a loop in the cable/wire that extends downward to the display. In this manner, two clasps at either end of the wire are used—one clasp engages the bracket, and the other clasp engages with the display. The system can engage with the ceiling in other manners. For example, a clasp is not necessary in that the looped end of the wire or cable can secure directly to the ceiling or a fixture in the ceiling.

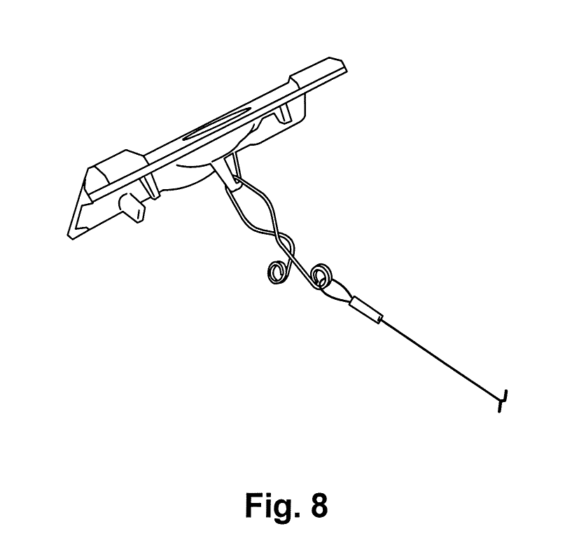

FIG. 8 shows the ceiling bracket with the claps attached and in the closed position to prevent inadvertent release of the clasp. The ceiling member can be an I-beam, in which case the bracket fits over the lower channel of the I-beam in a secure manner. Other arrangements are possible.

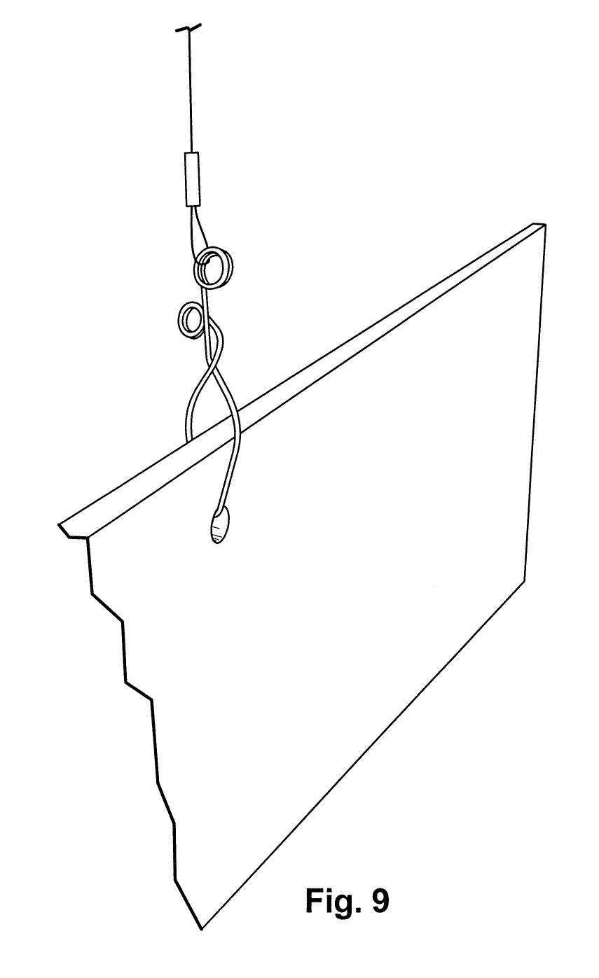

FIG. 9 shows the clasp attached to the display and in the closed position. In the manner shown the present invention solves the problems of the prior art by providing a ceiling display system that has minimal parts and hardware, but provides for secure attachment. The system is easy to secure and detach without the use of any tools, screw, nuts, bolts, or other hardware. The entire assembly and removal can be done by hand which greatly reduces the time and effort needed. Further, the system is strong, durable, and sufficiently pliable to allow for repeated and extended use.

While the preferred embodiment of the invention has been described in reference to the Figures, the invention is not so limited. Also, the method and apparatus of the present invention is not necessarily limited to digital signage, but can be applied to any field where real-time content verification is desired.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A display system, comprising:
a clasp having an open end that can be selectively engaged around the body of the clasp to open and close the clasp;
a display that can be secured to the clasp.

2. The invention of claim 1 further comprising a wire for connecting the clasp to a ceiling member.

3. The invention of claim 2 where the clasp further comprises an eyelet for engaging the wire.

4. The invention of claim 1 where the clasp is biased to a closed position.

5. The invention of claim 1 where the clasp has a first and second open end and the clasp is moved to the closed position by wrapping one end around the other forming a loop there-below.

6. The invention of claim 5 where the display is secured within the loop.

7. The invention of claim 1 further comprising a plurality of wires for connecting the clasp to a ceiling member.

8. The invention of claim 7 where the wires are color coded by length.

9. The invention of claim 1 further comprising a wire for connecting the clasp to a bracket that engages with a ceiling member.

10. The invention of claim 9 where the bracket has channels for engaging a ceiling member which is an I-Beam.

11. A display system, comprising:
a plurality of clasp each clasp have two open ends each with eyelets, which ends can be overlapped to close and open the clasps, where when closed each claps forms a closed loop;
a plurality of wires where each end of each wire engages with an eyelet of a clasp;
a ceiling member which engages with a bracket that at least one of the eyelets of the clasp can engage;
at least one display which engages with at least one clasp by having an eyelet pass through a hole in the display and the display secured in the loop formed with the clasp is closed.
